(19) United States
(12) Patent Application Publication
(10) Pub. No.: US 2026/0336497 A1
(43) Pub. Date: Oct. 29, 2026

(54) LOCKING SYSTEM AND VEHICLE TABLE APPARATUS INCLUDING THE SAME

(71) Applicant: HYUNDAI MOBIS CO., LTD., Seoul (KR)

(72) Inventor: Da Som PARK, Yongin-si (KR)

(73) Assignee: HYUNDAI MOBIS CO., LTD., Seoul (KR)

(21) Appl. No.: 19/563,934

(22) Filed: Mar. 11, 2026

(30) Foreign Application Priority Data
Apr. 23, 2025 (KR) 10-2025-0052854

(51) Int. Cl. B60N 3/00; B60R 21/045

(52) U.S. Cl. CPC B60N 3/002; B60R 21/045

(57) ABSTRACT

A locking system improved so that pull-out or storage of a table does not interfere with movement of the table, and a vehicle table apparatus including the same. A locking system for locking a table disposed in a crash pad of a vehicle in a withdrawable manner includes a rod unit movably disposed in a housing disposed inside the crash pad and in contact with both ends of the table to hold the table and a button unit movably disposed in the housing and configured to press the rod unit to move the rod unit, and the rod unit includes a first rod and a second rod configured to move in different directions when pressed or released by the button unit.

### CROSS-REFERENCE TO RELATED APPLICATION

This application claims priority to and the benefit of Korean Patent Application No. 10-2025-0052854, filed on Apr. 23, 2025, the disclosure of which is incorporated herein by reference in its entirety.

### BACKGROUND

### Field of the Invention

The present invention relates to a locking system and a vehicle table apparatus including the same.

### Discussion of Related Art

Modern vehicles are equipped with various convenient features. Among them, a table is used for the purpose of placing items, and the table may be mainly disposed in a passenger seat area of a crash pad.

This table may be pulled out of the crash pad when in use and may be moved to be stored in the crash pad after use. Here, a system for locking the table to prevent the table from protruding from the crash pad and causing injury to an occupant when not in use may be installed on the table.

Conventional locking systems are installed on a table to secure the table, but these conventional locking systems may serve as factors that hinder the table from being stored due to the occurrence of a vehicle collision or an external force transmitted to the table.

Accordingly, there is an increasing need for a table device equipped with a locking system having an improved structure that does not hinder movement of the table when the table is being stored, and furthermore, when the table is being pulled out.

### SUMMARY OF THE INVENTION

The present invention is intended to solve the above-described problems and is directed to providing a locking system that is improved so that pull-out or storage of a table does not interfere with movement of the table, and a vehicle table apparatus including the same.

According to an aspect of the present invention, there is provided a locking system for locking a table disposed in a crash pad of a vehicle in a withdrawable manner, which includes a rod unit movably disposed in a housing disposed inside the crash pad and in contact with both ends of the table to hold the table and a button unit movably disposed in the housing and configured to press the rod unit to move the rod unit, in which the rod unit includes a first rod and a second rod configured to move in different directions when pressed or released by the button unit.

The first rod of the rod unit may include a first hook configured to pass through the table when pressed by the button unit, the second rod of the rod unit includes a second hook configured to pass through the table when pressed by the button unit, and the first hook and the second hook may be disposed outside the table in a pulled-out state and continue to pass through the table in a state in which the table is stored.

The locking system may include a disk disposed at an upper side of the housing to rotate in place and a link unit connecting the disk and the rod unit.

The link unit may include a first link connecting the disk to the first rod of the rod unit and a second link connecting the disk to the second rod of the rod unit, and the first link and the second link may move in different directions in conjunction with movement of the first rod and the second rod of the rod unit.

The button unit may include a button block disposed to be exposed to the outside of the crash pad and a connecting module connecting the button block to the rod unit, and the connecting module may include a pressing portion disposed inside the crash pad and configured to press the first rod and the second rod of the rod unit and a connecting portion connecting the button block to the pressing portion such that the pressing portion is moved in conjunction with movement of the button block.

The first rod of the rod unit may be provided with a first inclined surface, the second rod of the rod unit may be provided with a second inclined surface symmetrical to the first inclined surface, and the pressing portion of the button unit may be provided with a third inclined surface that comes into contact with the first inclined surface and presses the first inclined surface and a fourth inclined surface that comes into contact with the second inclined surface and presses the second inclined surface.

When the button unit presses the first rod and the second rod of the rod unit, the first rod and the second rod may be moved toward the outside of the table, such that the table enters a withdrawable state.

The locking system may include a first elastic member connecting the housing to the first rod of the rod unit, a second elastic member connecting the housing to the second rod of the rod unit, and a third elastic member connecting the housing to the button unit.

According to another aspect of the present invention, there is provided a vehicle table apparatus including a table disposed in a crash pad of a vehicle and configured to move to be pulled out of or stored in the crash pad, a housing disposed inside the crash pad and configured to movably guide the table, and a locking system configured to lock or unlock the table disposed in the crash pad, in which the locking system may include a rod unit movably disposed in the housing disposed inside the crash pad and in contact with both ends of the table to hold the table and a button unit movably disposed in the housing and configured to press the rod unit to move the rod unit, and the rod unit may include a first rod and a second rod configured to move in different directions when pressed or released by the button unit.

The first rod of the rod unit may include a first hook configured to pass through the table when pressed by the button unit, the second rod of the rod unit includes a second hook configured to pass through the table when pressed by the button unit and a first locking groove configured to accommodate the first hook of the first rod and a second locking groove configured to accommodate the second hook of the second rod may be formed in the table.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view showing a vehicle table apparatus disposed in a crash pad according to one embodiment of the present invention;

FIG. 2 is a perspective view of a vehicle table apparatus according to one embodiment of the present invention;

FIG. 3 is an exploded perspective view of a vehicle table apparatus;

FIG. 4 is a perspective view of a table;

FIG. 5 is a perspective view of a housing unit;

FIG. 6A is an exploded perspective view of a housing unit;

FIG. 6B is a perspective view of a first guide block of a housing unit;

FIG. 7 is a view showing a locking system;

FIG. 8 is an exploded perspective view of the locking system;

FIG. 9 is a view showing a rod unit;

FIG. 10A is a view showing a first hook of a first rod disposed in a first locking groove of a table;

FIG. 10B is a view showing a second hook of a second rod disposed in a second locking groove of a table;

FIG. 11 is an exploded perspective view of a button unit;

FIG. 12 is a view showing an elastic member coupled to a rod unit and a button unit;

FIG. 13 is a view showing a locking system disposed in a housing unit;

FIG. 14 is a view showing a disk coupled to a housing and a link unit connecting the disk to a rod unit;

FIG. 15 is a view showing a state before a button block of a button unit is pressed;

FIG. 16 is a view showing a button block of a button unit in a pressed state; and

FIG. 17 is a view showing a first hook of a first rod in contact with a table after the table is pulled out.

### DETAILED DESCRIPTION OF EXEMPLARY EMBODIMENTS

Since the present invention may be embodied with various modifications, particular embodiments thereof will be illustrated in the drawings and described. However, this is not intended to limit the present invention to the specific embodiments, and it should be understood to include all modifications, equivalents, and substitutes included in the spirit and scope of the present invention.

Although terms including ordinal numbers such as “first,” “second,” or the like may be used to describe various elements, these elements are not limited by these terms. These terms are only used to distinguish one element from another element. For example, without departing from the scope of the present invention, a second element could be termed a first element, and similarly, a first element could be termed a second element. The term “and/or” includes a combination of a plurality of related listed items or any of a plurality of related listed items.

It will be understood that when an element is referred to as being “coupled” or “connected” to another element, the element may be directly coupled or connected to the other element, or intervening elements may also be present. In contrast, it will be understood that when an element is referred to as being “directly coupled” or “directly connected” to another element, there are no intervening elements present.

In the description of embodiments, when one element is described as being formed “on” or “under” another element, “on” or “under” includes both a case in which the two elements are directly in contact with each other and a case in which at least one additional element is formed to be disposed between the two elements (indirectly). Further, the expression as “on” or “under” may include the meaning of not only an upward direction but also a downward direction based on one element.

Terms used in the present application are merely provided to describe specific embodiments and are not intended to limit the present invention. The singular forms are intended to include the plural forms as well, unless the context clearly indicates otherwise. In the present application, it will be understood that the terms “include,” “have,” and the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

Unless otherwise defined, all terms used herein, including technical or scientific terms, have the same meaning as commonly understood by those of ordinary skill in the art to which the present invention belongs. Terms, such as those defined in commonly used dictionaries, should be interpreted as having meanings that are consistent with their meanings in the context of the related art and will not be interpreted in an idealized or overly formal sense unless expressly so defined herein.

Hereinafter, a locking system and a vehicle table apparatus including the same will be described in detail with reference to the accompanying drawings, but identical or corresponding components are denoted by the same reference numerals throughout the drawings, and redundant descriptions thereof will be omitted.

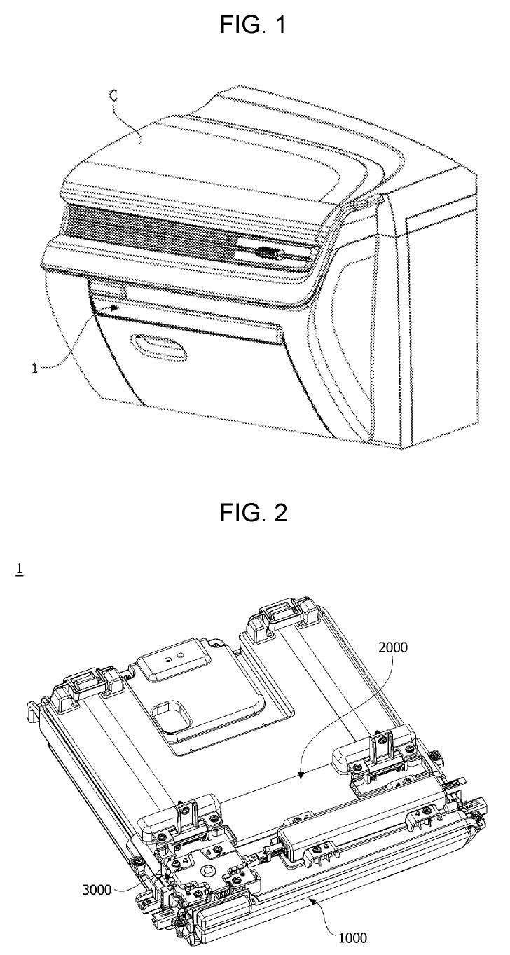

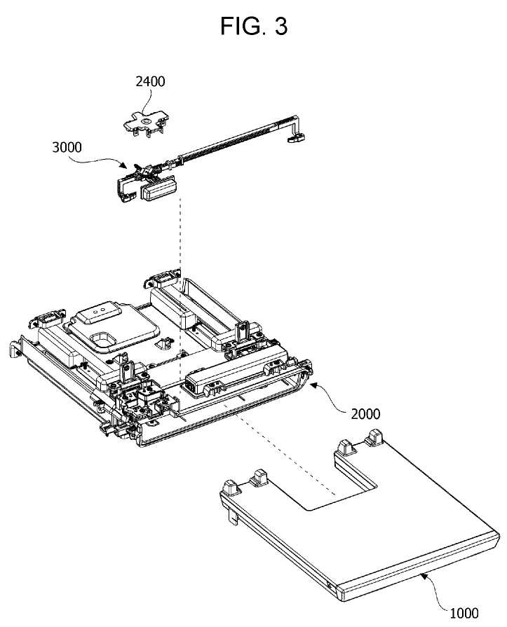

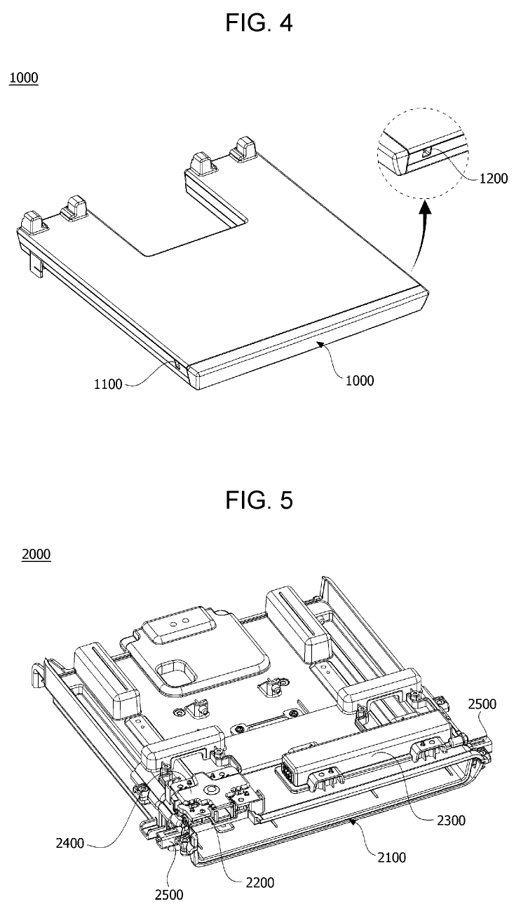

FIG. 1 is a view showing a vehicle table apparatus disposed in a crash pad according to one embodiment of the present invention, FIG. 2 is a perspective view of the vehicle table apparatus according to one embodiment of the present invention, and FIG. 3 is an exploded perspective view of the vehicle table apparatus.

First, a width direction used in the present embodiment may be a direction toward a passenger seat from a driver’s seat inside a vehicle or a reverse direction thereof, a length direction may be a direction intersecting the width direction or a direction toward an engine room from a passenger room of the vehicle or a reverse direction thereof, and a height direction may be a direction perpendicularly intersecting the width direction and the length direction or a direction toward a ceiling surface from a floor surface of the passenger room or a reverse direction thereof.

Referring to FIGS. 1-3, a vehicle table apparatus 1 according to one embodiment of the present invention may be disposed in a crash pad C installed inside a vehicle and may be disposed in a region of the crash pad C facing the passenger seat. In addition, the vehicle table apparatus 1 may be disposed at an upper side of the glove box disposed in the crash pad C but is not limited thereto. The vehicle table apparatus 1 according to one embodiment of the present invention may include a table 1000, a housing unit 2000, and a locking system 3000.

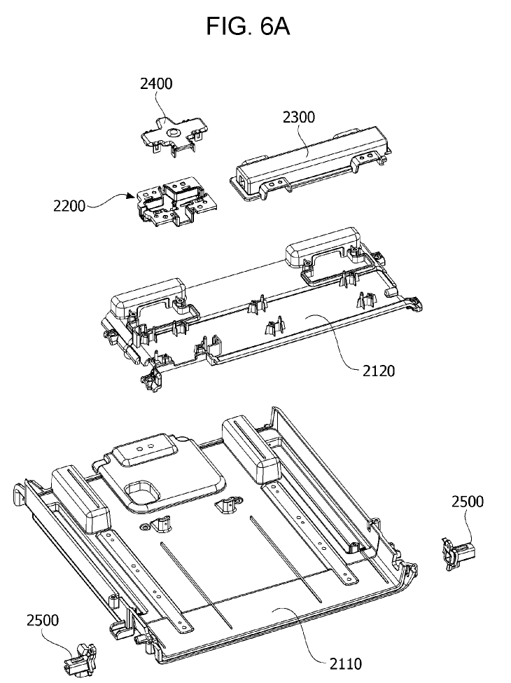

FIG. 4 is a perspective view of the table.

Referring to FIG. 4, the table 1000 may be disposed in the crash pad C of the vehicle and moved to be pulled out of or stored in the crash pad C. More specifically, the table 1000 may be disposed to be stored in or pulled out of a housing 2100 of the housing unit 2000, which will be described below. The table 1000 may be collinear with the crash pad C or may protrude a predetermined distance from an outer surface of the crash pad C when stored.

A first locking groove 1100 and a second locking groove 1200 may be formed in the table 1000. The first locking groove 1100 may be formed in one side of the table 1000, and the second locking groove 1200 may be formed in the other side of the table 1000. Here, the first locking groove 1100 and the second locking groove 1200 may be disposed to be collinear. The first locking groove 1100 may accommodate a first hook 3113 of a first rod 3110, which will be described below, and the second locking groove 1200 may accommodate a second hook 3123 of a second rod 3120, which will be described below.

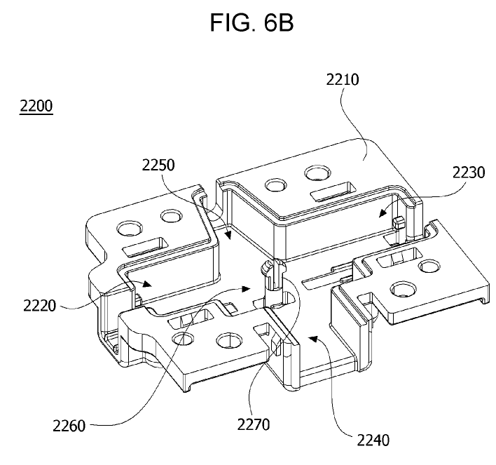

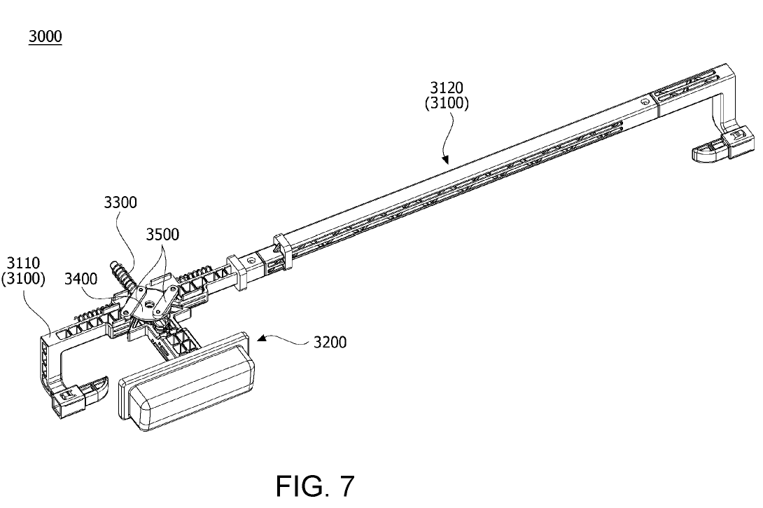

FIG. 5 is a perspective view of the housing unit, FIG. 6A is an exploded perspective view of the housing unit, and FIG. 6B is a perspective view of a first guide block of the housing unit.

Referring to FIGS. 5 and 6A, the housing unit 2000 may be coupled to the table 1000 and may support the locking system 3000. The housing unit 2000 may include the housing 2100, a first guide block 2200, a second guide block 2300, a cover 2400, and a third guide block 2500.

The housing 2100 may be disposed inside the crash pad C and may movably guide the table 1000. The housing 2100 may include a first housing plate 2110 and a second housing plate 2120.

The first housing plate 2110 may have a shape surrounding one region of the table 1000. For example, the first housing plate 2110 may have a shape with one side open. The first housing plate 2110 may have a length corresponding to or longer than a length of the table 1000.

The second housing plate 2120 may be disposed on the upper side of the first housing plate 2110 and may be coupled to the first housing plate 2110. The second housing plate 2120 may have a shape surrounding the other region of the table 1000 that is not surrounded by the first housing plate 2110. When the second housing plate 2120 is coupled to the first housing plate 2110, a space in which the table 1000 can be moved to be pulled out or stored may be formed in the housing 2100.

Referring to FIGS. 5, 6A and 6B, and particularly referring to FIG. 6B, the first guide block 2200 may be coupled to the second housing plate 2120 of the housing 2100. The first guide block 2200 may be disposed at the upper side of the second housing plate 2120 and coupled to the second housing plate 2120. The first guide block 2200 may include a first body 2210, a first guide groove 2220, a second guide groove 2230, a third guide groove 2240, a fourth guide groove 2250, a connecting groove 2260, and a coupling protrusion 2270.

The first body 2210 may form an exterior of the first guide block 2200. The first body 2210 may be fixed to the second housing plate 2120 through a fixing member such as a bolt or the like. The first body 2210 may have a shape that is bent a plurality of times so that the grooves and the coupling protrusion 2270 may be formed.

The first guide groove 2220 may accommodate the first rod 3110 and a first elastic member 3310, which will be described below, and may be disposed in the first body 2210 in the width direction. The second guide groove 2230 may accommodate the second rod 3120 and a second elastic member 3320, which will be described below, and may be disposed in the first body 2210 in the width direction. The second guide groove 2230 may be spaced apart from the first guide groove 2220 in the width direction with the connecting groove 2260 interposed therebetween.

The third guide groove 2240 may accommodate a connecting portion 3222 of a connecting module 3220, which will be described below, and may be disposed in the first body 2210 in the length direction. The fourth guide groove 2250 may accommodate a third support protrusion 3224 and a third elastic member 3330 of the connecting module 3220, which will be described below, and may be disposed in the first body 2210 in the length direction. The fourth guide groove 2250 may be spaced apart from the third guide groove 2240 with the connecting groove 2260 interposed therebetween in the length direction. Here, the fourth guide groove 2250 may allow the third support protrusion 3224 of the connecting module 3220, which will be described below, to move to protrude outward from the first guide block 2200 in the length direction.

The connecting groove 2260 may be disposed between the first guide groove 2220 and the second guide groove 2230 and may be disposed between the third guide groove 2240 and the fourth guide groove 2250. This connecting groove 2260 may be connected to each guide groove. The connecting groove 2260 may accommodate the first rod 3110, the second rod 3120, and a pressing portion 3221 of the connecting module 3220, which will be described below.

The coupling protrusion 2270 may be disposed at a position where the connecting groove 2260 is disposed in the first body 2210. The coupling protrusion 2270 may have a shape that protrudes from the first body 2210 in the height direction. The coupling protrusion 2270 may pass through the pressing portion 3221 of the connecting module 3220, which will be described below, and may be coupled to a disk 3400, which will be described below, to support the disk 3400.

Referring again to FIGS. 5 and 6A, the second guide block 2300 may be coupled to the first body 2210 and may be disposed at the upper side of the first body 2210. The second guide block 2300 may be disposed parallel to the first guide block 2200 in the width direction. The second guide block 2300 may be spaced apart from the first guide block 2200 in the width direction. The second guide block 2300 may be coupled to the second rod 3120, which will be described below, and may guide the second rod 3120. This second guide block 2300 may surround the second rod 3120 while coupled to the first body 2210.

The cover 2400 may be coupled to the first guide block 2200. The cover 2400 may be disposed at the upper side of the first guide block 2200 in the height direction. The cover 2400 may be coupled to the first guide block 2200 to protect some components of the locking system 3000.

The third guide block 2500 may be coupled to the first housing plate 2110 of the housing 2100. The third guide block 2500 may be disposed on a side portion of the first housing plate 2110. A plurality of third guide blocks 2500 may be provided. The third guide block 2500 may guide a movement direction of the first hook 3113 of the first rod 3110 and the second hook 3123 of the second rod 3120, which will be described below.

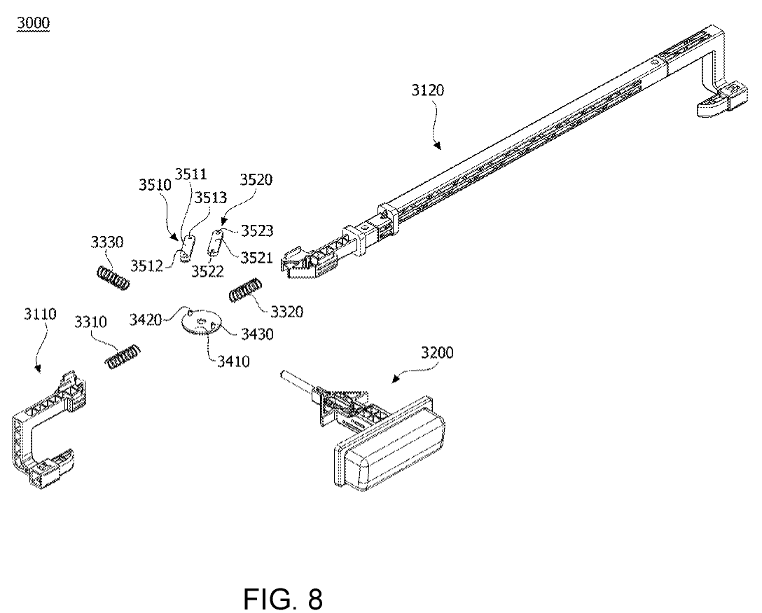

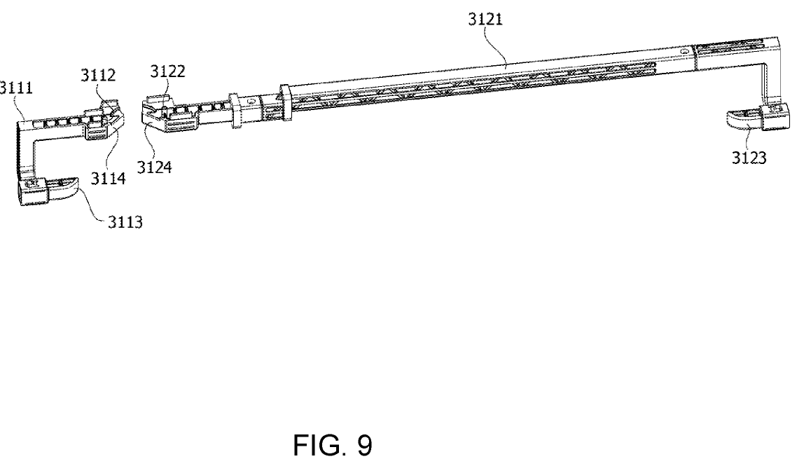

FIG. 7 is a view showing a locking system, and FIG. 8 is an exploded perspective view of the locking system.

Referring to FIGS. 7 and 8, a locking system 3000 may lock or unlock the table 1000 disposed in the crash pad C to allow the table to be pulled out. The locking system 3000 may include a rod unit 3100, a button unit 3200, an elastic member 3300, a disk 3400, and a link unit 3500.

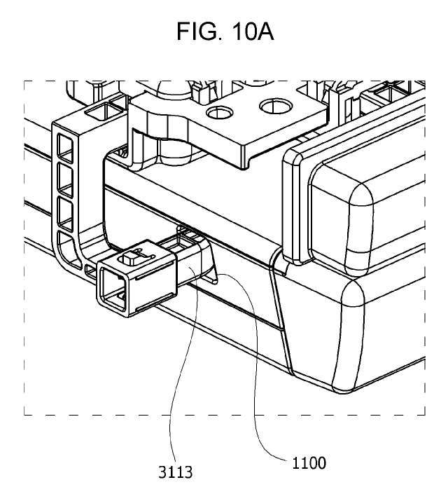

FIG. 9 is a view showing the rod unit.

Referring to FIGS. 7-9, the rod unit 3100 may be movably disposed in the housing 2100 disposed inside the crash pad C and may be in contact with both ends of the table 1000 and hold the table 1000. The rod unit 3100 may include a first rod 3110 and a second rod 3120.

The first rod 3110 may include a first rod frame 3111, a first support protrusion 3112, and a first hook 3113.

The first rod frame 3111 may be disposed on the first guide block 2200 of the housing unit 2000. More specifically, the first rod frame 3111 may be movably disposed in the connecting groove 2260 and the first guide groove 2220 of the first guide block 2200. The first rod frame 3111 may be moved in the width direction by the button unit 3200. The first rod frame 3111 may have a shape that is bent a plurality of times. Accordingly, a portion of the first rod frame 3111 that is not disposed on the first guide block 2200 of the housing unit 2000 may be disposed outside the housing 2100 and the first guide block 2200 of the housing unit 2000 in the width direction.

The first support protrusion 3112 may be disposed on the first rod frame 3111. The first support protrusion 3112 may have a shape that protrudes from the first rod frame 3111 in the height direction. The first support protrusion 3112 may be coupled to a first link 3510, which will be described below.

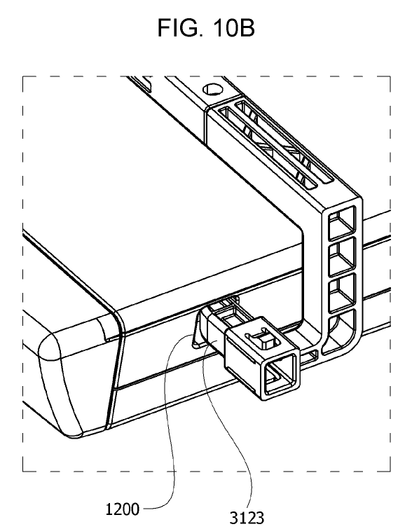

FIG. 10A is a view showing the first hook of the first rod disposed in the first locking groove of the table.

Referring to FIGS. 9 and 10A, the first hook 3113 may be disposed at an end portion of the first rod frame 3111. The first hook 3113 may be disposed at an end portion of a region of the frame of the first rod 3110 that is not disposed on the first guide block 2200 of the housing unit 2000. The first hook 3113 may have a wedge shape. The first hook 3113 may be disposed parallel to a region of the first rod frame 3111 disposed on the first guide block 2200 of the housing 2100.

The first hook 3113 may pass through the table 1000 when pressed by the button unit 3200. More specifically, the first hook 3113 may be accommodated in the first locking groove 1100 formed in the table 1000. Accordingly, in a state in which the button unit 3200 is not pressed, the first hook 3113 accommodated in the first locking groove 1100 of the table 1000 may remain, and in a state in which the button unit 3200 is pressed, the first hook 3113 may be disengaged from the first locking groove 1100 of the table 1000 such that the accommodated state of the first hook 3113 in the first locking groove 1100 may be released.

The second rod 3120 may include a second rod frame 3121, a second support protrusion 3122, and a second hook 3123.

The second rod frame 3121 may be disposed on the first guide block 2200 of the housing unit 2000. More specifically, the second rod frame 3121 may be movably disposed in the connecting groove 2260 and the second guide groove 2230 of the first guide block 2200. In addition, the second rod frame 3121 may be coupled to the second guide block 2300 and moved while being guided by the second guide block 2300. The second rod frame 3121 may be moved by the button unit 3200 in the width direction. In this case, the second rod frame 3121 may be moved in a different direction from the first rod frame 3111 of the first rod 3110 in the width direction.

The second rod frame 3121 may have a shape that is bent a plurality of times. Accordingly, a portion of the second rod frame 3121 that is not disposed on the first guide block 2200 of the housing unit 2000 may be disposed outside the housing 2100 and the second guide block 2300 of the housing unit 2000 in the width direction.

The second support protrusion 3122 may be disposed on the second rod frame 3121. The second support protrusion 3122 may have a shape that protrudes from the second rod frame 3121 in the height direction. The first support protrusion 3112 may be coupled to a second link 3520, which will be described below.

FIG. 10B is a view showing the second hook of the second rod disposed in the second locking groove of the table.

Referring to FIGS. 9 and 10B, the second hook 3123 may be disposed at an end portion of the second rod frame 3121. The second hook 3123 may be disposed at an end portion of a region of the frame of the second rod 3120 that is not disposed in the first guide block 2200 and the second guide block 2300 of the housing unit 2000. The second hook 3123 may have a wedge shape. The second hook 3123 may be disposed parallel to a region of the second rod frame 3121 disposed on the first guide block 2200 and the second guide block 2300 of the housing 2100.

The second hook 3123 may pass through the table 1000 when pressed by the button unit 3200. More specifically, the second hook 3123 may be accommodated in the second locking groove 1200 formed in the table 1000. Accordingly, in a state in which the button unit 3200 is not pressed, the second hook 3123 accommodated in the second locking groove 1200 of the table 1000 may remain, and in a state in which the button unit 3200 is pressed, the second hook 3123 may be disengaged from the second locking groove 1200 of the table 1000 such that the accommodated state of the second hook 3123 in the second locking groove 1200 may be released.

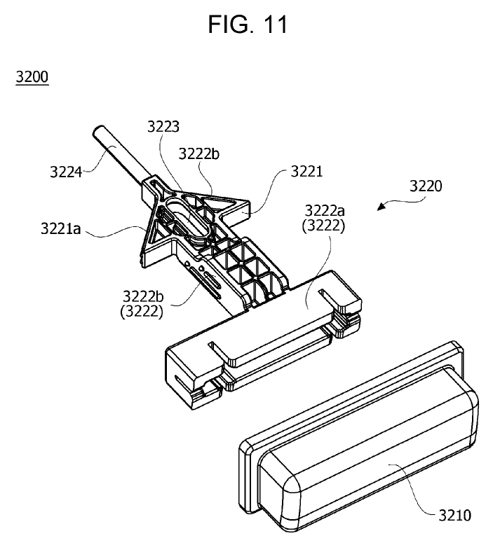

FIG. 11 is an exploded perspective view of the button unit.

Referring to FIGS. 7, 8 and 11, the button unit 3200 may be movably disposed in the housing 2100 and may press the rod unit 3100 so that the rod unit 3100 is moved. The button unit 3200 may include a button block 3210 and the connecting module 3220.

The button block 3210 may be disposed to be exposed to the outside of the crash pad C. An edge portion of this button block 3210 may be formed to be larger than a hole formed in the crash pad C to accommodate the vehicle table apparatus 1. Accordingly, the button block 3210 is prevented from being separated outside the crash pad C. In addition, the button block 3210 may have a hollow interior to accommodate a portion of the connecting module 3220.

The connecting module 3220 may connect the button block 3210 to the rod unit 3100. The connecting module 3220 may include a pressing portion 3221, a connecting portion 3222, a guide hole 3223, and a third support protrusion 3224.

The pressing portion 3221 may be disposed inside the crash pad C and press the first rod 3110 and the second rod 3120 of the rod unit 3100. The pressing portion 3221 may be movably disposed in the connecting groove 2260 formed in the first guide block 2200 of the housing unit 2000. The pressing portion 3221 in contact with the first rod 3110 and the second rod 3120 may remain while disposed in the connecting groove 2260 of the first guide block 2200. When the button block 3210 is pressed, the pressing portion 3221 may move the first rod 3110 and the second rod 3120 while moving in the length direction in conjunction with the movement of the button block 3210. The pressing portion 3221 may have a wedge shape.

The connecting portion 3222 may be coupled to the pressing portion 3221. The connecting portion 3222 may be integrally formed with the pressing portion 3221. The connecting portion 3222 may connect the button block 3210 to the pressing portion 3221 and move the pressing portion 3221 in conjunction with the movement of the button block 3210. The connecting portion 3222 may include a first connecting portion 3221a connected to the button block 3210 and a second connecting portion 3221b connected to the first connecting portion 3221a and connected to the pressing portion 3221. The first connecting portion 3221a and the second connecting portion 3221b may be disposed in different directions. For example, the first connecting portion 3221a may be disposed in the width direction, and the second connecting portion 3221b may be disposed in the length direction.

The guide hole 3223 may be formed across the pressing portion 3221 and the connecting portion 3222. The guide hole 3223 may have an elongated hole shape and may be disposed in the length direction. The guide hole 3223 may accommodate the coupling protrusion 2270 of the first guide block 2200 of the housing 2100 therein. Accordingly, when the button block 3210 is pressed and the button unit 3200 moves, the pressing portion 3221 comes into contact with the coupling protrusion 2270 of the first guide block 2200 disposed inside the guide hole 3223, and thus the movement of the button block 3210 may be stopped.

The third support protrusion 3224 may be disposed at an end portion of the pressing portion 3221. The third support protrusion 3224 may have a cylindrical shape protruding from the pressing portion 3221 in the length direction. The third support protrusion 3224 may be movably disposed in the fourth guide groove 2250 of the first guide block 2200 of the housing unit 2000 and may be coupled to the third elastic member 3330 which will be described below.

Hereinafter, a structure in which the button block 3210 comes into contact with the first rod 3110 and the second rod 3120 is described.

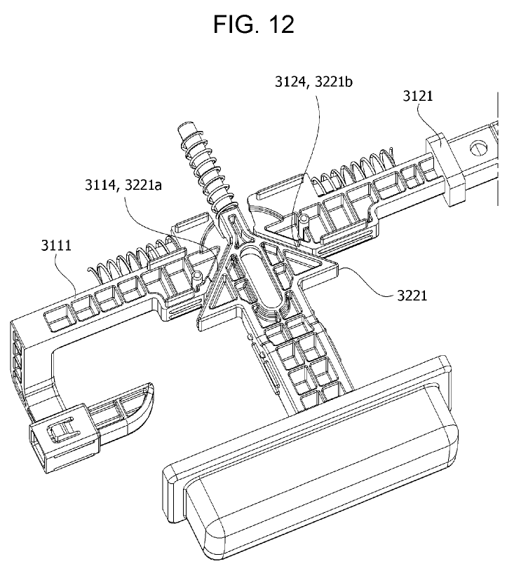

FIG. 12 is a view showing an elastic member coupled to the rod unit and the button unit.

Referring to FIGS. 9, 11, and 12, first, the first rod 3110 of the rod unit 3100 may be provided with a first inclined surface 3114, and the second rod 3120 of the rod unit 3100 may be provided with a second inclined surface 3124. More specifically, the first inclined surface 3114 may be formed at an end portion of the first rod frame 3111 of the first rod 3110 that is disposed on the first guide block 2200 of the housing unit 2000. In addition, the second inclined surface 3124 may be formed at an end portion of the second rod frame 3121 of the second rod 3120 that is disposed on the first guide block 2200 of the housing unit 2000. The first inclined surface 3114 and the second inclined surface 3124 may be symmetrical to each other.

Next, a third inclined surface 3221a that comes into contact with the first inclined surface 3114 of the first rod 3110 and presses the first inclined surface 3114 and a fourth inclined surface 3221b that comes into contact with the second inclined surface 3124 of the second rod 3120 and presses the second inclined surface 3124 may be formed on the pressing portion 3221 of the button unit 3200. In a state in which the rod unit 3100 and the button unit 3200 are disposed on the first guide block 2200 of the housing unit 2000, the third inclined surface 3221a may be disposed parallel to the first inclined surface 3114, and the fourth inclined surface 3221b may be disposed parallel to the second inclined surface 3124.

Accordingly, when the button block 3210 is pressed, the third inclined surface 3221a of the pressing portion 3221 may press the first inclined surface 3114 of the first rod 3110 while moving in the length direction, so that the first rod 3110 may be moved in the width direction, and the fourth inclined surface 3221b of the pressing portion 3221 presses the second inclined surface 3124 of the second rod 3120 while moving in the length direction, and thus the second rod 3120 may be moved in the width direction. In this case, a state in which the first inclined surface 3114 and the third inclined surface 3221a are in contact with each other may be continuously maintained, and a state in which the second inclined surface 3124 and the fourth inclined surface 3221b are in contact with each other may be continuously maintained.

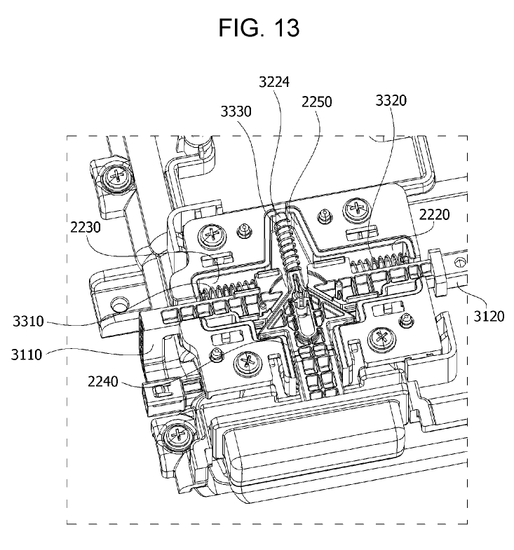

FIG. 13 is a view showing the locking system disposed in the housing unit.

Referring to FIGS. 7, 8, and 13, the elastic member 3300 may include a first elastic member 3310, a second elastic member 3320, and a third elastic member 3330.

The first elastic member 3310 may be disposed in the first guide groove 2220 of the first guide block 2200 of the housing unit 2000 and coupled to the first rod 3110. The first elastic member 3310 may connect the housing 2100 to the first rod 3110 of the rod unit 3100.

In a state in which the button unit 3200 does not press the first rod 3110, the first elastic member 3310 in an uncompressed state is maintained. When the button unit 3200 presses the first rod 3110, the first elastic member 3310 may be compressed by the first rod 3110. When the state in which the button unit 3200 presses the first rod 3110 is released, the compressed first elastic member 3310 generates an elastic restoring force as the compression is released, thereby assisting return movement of the first rod 3110.

The second elastic member 3320 may be disposed in the second guide groove 2230 of the first guide block 2200 of the housing unit 2000 and coupled to the second rod 3120. The second elastic member 3320 may connect the housing 2100 to the second rod 3120 of the rod unit 3100.

In the state in which the button unit 3200 does not press the first rod 3110, the first elastic member 3310 in the uncompressed state is maintained. When the button unit 3200 presses the first rod 3110, the first elastic member 3310 may be compressed by the first rod 3110. When the state in which the button unit 3200 presses the first rod 3110 is released, the compressed first elastic member 3310 generates an elastic restoring force as the compression is released, thereby assisting return movement of the first rod 3110.

The third elastic member 3330 may be disposed in the fourth guide groove 2250 of the first guide block 2200 of the housing unit 2000 and coupled to the third support protrusion 3224 of the connecting module 3220. The third elastic member 3330 may connect the housing 2100 to the button unit 3200.

In the state in which the button unit 3200 does not press the second rod 3120, the second elastic member 3320 in the uncompressed state is maintained. When the button unit 3200 presses the second rod 3120, the second elastic member 3320 may be compressed by the second rod 3120. When the state in which the button unit 3200 presses the second rod 3120 is released, the compressed second elastic member 3320 generates an elastic restoring force as the compression is released, thereby assisting return movement of the second rod 3120.

In the state in which the button unit 3200 does not press the first rod 3110 and the second rod 3120, the third elastic member 3330 in the uncompressed state is maintained. When the button unit 3200 presses the first rod 3110 and the second rod 3120, the third elastic member 3330 may be compressed by the third support protrusion 3224 of the connecting module 3220. When the state in which the button unit 3200 presses the first rod 3110 and the second rod 3120 is released, the compressed third elastic member 3330 generates an elastic restoring force as the compression is released, thereby assisting return movement of the third support protrusion 3224.

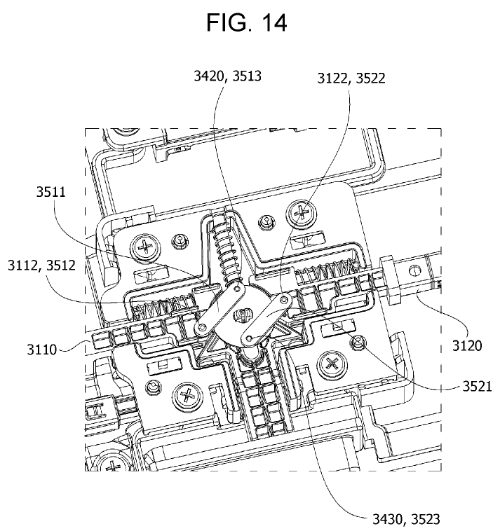

FIG. 14 is a view showing the disk coupled to the housing and the link unit connecting the disk to the rod unit.

Referring to FIGS. 7, 8 and 14, the disk 3400 may be disposed at the upper side of the housing 2100 of the housing unit 2000 to rotate in place. The disk 3400 may include a second body 3410, a fourth support protrusion 3420, and a fifth support protrusion 3430.

The second body 3410 may form an exterior of the disk 3400. The second body 3410 may be coupled to the coupling protrusion 2270 of the first guide block 2200 of the housing unit 2000.

The fourth support protrusion 3420 and the fifth support protrusion 3430 may protrude from the second body 3410 in the height direction. Based on the center of the disk 3400, the fourth support protrusion 3420 may be disposed close to the first rod 3110, and the fifth support protrusion 3430 may be disposed close to the second rod 3120. The fourth support protrusion 3420 may be coupled to a first link 3510, which will be described below, and the fifth support protrusion 3430 may be coupled to a second link 3520, which will be described below.

Referring to FIGS. 7, 8 and 14, the link unit 3500 may connect the disk 3400 to the rod unit 3100. The link unit 3500 may include the first link 3510 and the second link 3520.

The first link 3510 may connect the disk 3400 to the first rod 3110. The first link 3510 may include a third body 3511, a first accommodation hole 3512, and a second accommodation hole 3513.

The third body 3511 may form an exterior of the first link 3510. The third body 3511 may be a rectangular plate with rounded corners. The third body 3511 may be disposed at the upper side of the first rod 3110 and the disk 3400.

The second accommodation hole 3513 and a third accommodation hole 3522 may be formed in the third body 3511. The second accommodation hole 3513 and the third accommodation hole 3522 may be formed at one end portion and the other end portion of the third body 3511, respectively. The second accommodation hole 3513 may accommodate the first support protrusion 3112 of the first rod 3110, and the third accommodation hole 3522 may accommodate the fourth support protrusion 3420 of the disk 3400. That is, the disk 3400 and the first rod 3110 may be connected by the first support protrusion 3112 and the fourth support protrusion 3420 accommodated in the second accommodation hole 3513 and the third accommodation hole 3522.

The second link 3520 may connect the disk 3400 to the second rod 3120. The second link 3520 may include a fourth body 3521, a third accommodation hole 3522, and a fourth accommodation hole 3523.

The fourth body 3521 may form an exterior of the second link 3520. The fourth body 3521 may be a rectangular plate with rounded corners. The fourth body 3521 may be disposed at the upper side of the second rod 3120 and the disk 3400.

The third accommodation hole 3522 and the fourth accommodation hole 3523 may be formed in the fourth body 3521. The third accommodation hole 3522 and the fourth accommodation hole 3523 may be formed at one end portion and the other end portion of the fourth body 3521, respectively. The third accommodation hole 3522 may accommodate the second support protrusion 3122 of the second rod 3120, and the fourth accommodation hole 3523 may accommodate the fifth support protrusion 3430 of the disk 3400. That is, the disk 3400 and the second rod 3120 may be connected by the second support protrusion 3122 and the fifth support protrusion 3430 accommodated in the third accommodation hole 3522 and the fourth accommodation hole 3523.

Referring again to FIG. 14, the first link 3510 and the second link 3520 may move in different directions in conjunction with the movement of the first rod 3110 and the second rod 3120 of the rod unit 3100. This may limit a range of movement of the first rod 3110 and the second rod 3120.

More specifically, when the button block 3210 presses the first rod 3110, the first rod 3110 pulls the first link 3510 connected to the first support protrusion 3112 of the first rod 3110 while moving in the width direction. In this manner, the first link 3510 moves along the first rod 3110, and the fourth support protrusion 3420 of the disk 3400 accommodated in the second accommodation hole 3513 of the first link 3510 moves along the first link 3510.

When the disk 3400 moves along the first link 3510, the disk 3400 rotates in place around the coupling protrusion 2270 of the first guide block 2200 of the housing unit 2000. Therefore, based on FIG. 14, the fourth support protrusion 3420 of the disk 3400 rotates counterclockwise. As a result, the first link 3510 is moved leftward in the width direction by the first rod 3110 and the disk 3400.

Conversely, when the button block 3210 presses the second rod 3120, the second rod 3120 pulls the second link 3520 connected to the second support protrusion 3122 of the second rod 3120 while moving in the width direction. In this manner, the second link 3520 moves along the second rod 3120, and the fifth support protrusion 3430 of the disk 3400 accommodated in the fourth accommodation hole 3523 of the second link 3520 moves along the second link 3520.

When the disk 3400 moves along the second link 3520, the disk 3400 rotates in place around the coupling protrusion 2270 of the first guide block 2200 of the housing unit 2000. Therefore, based on FIG. 14, the fifth support protrusion 3430 of the disk 3400 rotates counterclockwise. As a result, the second link 3520 is moved rightward in the width direction by the second rod 3120 and the disk 3400.

In this way, the rotation of the disk 3400 may be stopped by the first link 3510 and the second link 3520 that are moved in different directions by the movement of the button unit 3200. Accordingly, the rotation of the first link 3510 and the second link 3520 connected to the disk 3400 is also stopped, whereby the width-direction movement of the first rod 3110 connected to the first link 3510 is stopped, and the width-direction movement of the second rod 3120 connected to the second link 3520 is stopped. That is, the interlinked movement of the rod unit 3100, the disk 3400, and the link unit 3500 may limit the range of movement of the rod unit 3100, thereby preventing the first rod 3110 and the second rod 3120 from excessively moving.

Accordingly, in the process of storing the table 1000, the phenomenon in which the first hook 3113 of the first rod 3110 and the second hook 3123 of the second rod 3120 are not accommodated in the first locking groove 1100 and the second locking groove 1200 of the table 1000 may be prevented. That is, the locking performance of the table 1000 of the locking system may be maintained.

Hereinafter, a structure in which the table 1000 may be pulled out or stored will be described.

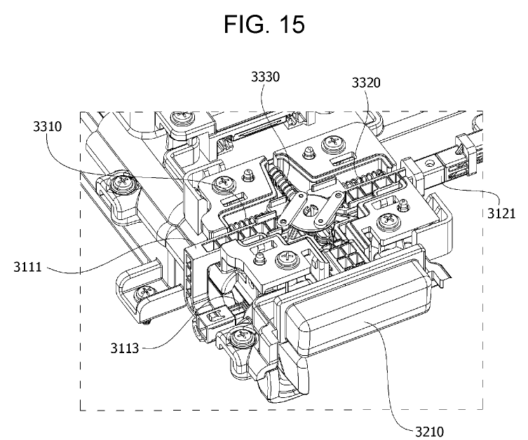

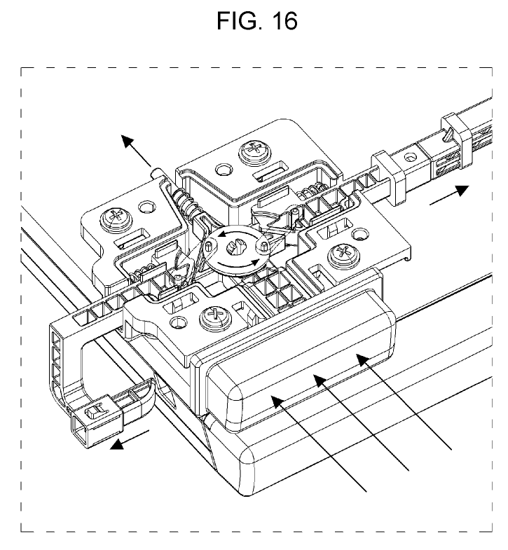

FIG. 15 is a view showing a state before the button block of the button unit is pressed, and FIG. 16 is a view showing the button block of the button unit in a pressed state.

Referring to FIG. 15, in the state before the button block 3210 of the button unit 3200 is pressed, the first hook 3113 of the first rod 3110 is accommodated in the first locking groove 1100 of the table 1000, and the second hook 3123 of the second rod 3120 is accommodated in the second locking groove 1200 of the table 1000. In addition, the first elastic member 3310, the second elastic member 3320, and the third elastic member 3330 in uncompressed states are maintained.

Referring to FIGS. 1 to 16, and particularly to FIGS. 15 and 16, in the state described above, when the button block 3210 is pressed, the connecting portion 3222 and the pressing portion 3221 of the connecting module 3220 are advanced along the button block 3210 in the length direction, and the first inclined surface 3114 of the first rod 3110 and the second inclined surface 3124 of the second rod 3120 that are in contact with the third inclined surface 3221a and the fourth inclined surface 3221b of the pressing portion 3221 of the connecting module 3220 are moved in the width direction intersecting the length direction. In this case, the first elastic member 3310 connected to the first rod 3110 is compressed in the width direction, the second elastic member 3320 connected to the second rod 3120 is compressed in the width direction, and the third elastic member 3330 connected to the third support protrusion 3224 of the connecting module 3220 is compressed in the length direction.

In this way, when the first rod 3110 and the second rod 3120 move in the width direction, the first hook 3113 of the first rod 3110 accommodated in the first locking groove 1100 of the table 1000 is separated from the first locking groove 1100, and the second hook 3123 of the second rod 3120 accommodated in the second locking groove 1200 of the table 1000 is separated from the second locking groove 1200. In this manner, the state in which the table 1000 is locked by the locking system 3000 is released, and the table 1000 may then be pulled out of the housing 2100. Finally, the table 1000 may be pulled out of the housing 2100 and protrude from the crash pad C, so that the table may enter a usable state for an occupant.

Conversely, when the use of the table 1000 is terminated and the table 1000 is pressed in the length direction so that the table 1000 is stored, the table 1000 is moved so that the table may be stored inside the housing 2100. In this case, in the process of moving the table 1000 to be stored in the housing 2100, the first hook 3113 of the first rod 3110 and the second hook 3123 of the second rod 3120 may enter the first locking groove 1100 and the second locking groove 1200 of the table 1000.

In the process in which the first hook 3113 of the first rod 3110 enters the first locking groove 1100 of the table 1000, the first rod 3110 may move toward the pressing portion 3221 of the connecting module 3220 of the button unit 3200 in the width direction. In this case, the compression of the compressed first elastic member 3310 is released, and an elastic restoring force is generated. In addition, in the process in which the second hook 3123 of the second rod 3120 enters the second locking groove 1200 of the table 1000, the second rod 3120 may move toward the pressing portion 3221 of the connecting module 3220 of the button unit 3200 in the width direction. In this case, the compression of the compressed second elastic member 3320 is released, and an elastic restoring force is generated.

In this way, when the first rod 3110 and the second rod 3120 are brought into a return movement, the first inclined surface 3114 of the first rod 3110 and the second inclined surface 3124 of the second rod 3120 press the third inclined surface 3221a and the fourth inclined surface 3221b of the pressing portion 3221 of the connecting module 3220. In this manner, the pressing portion 3221 of the connecting module 3220 retreats in the length direction. Accordingly, the button block 3210, the connecting module 3220 and the elastic member 3300 of the button unit 3200 are returned to positions of a pre-pressed state. Finally, the table 1000 is stored in the housing 2100, and the table 1000 is maintained in a locked state by the first hook 3113 of the first rod 3110 and the second hook 3123 of the second rod 3120.

As described above, the vehicle table apparatus 1 according to one embodiment of the present invention may stably maintain the locked state of the table 1000 by the first rod 3110 and the second rod 3120 that move in different directions when pressed or released by the button unit 3200. More specifically, the first hook 3113 of the first rod 3110 and the second hook 3123 of the second rod 3120 may continue to pass through the table 1000 while the table 1000 is stored.

Accordingly, in the state where the table 1000 is stored, a state in which the first hook 3113 and the second hook 3123 lock the table 1000 is not released, and only when the button unit 3200 is pressed with a force that overcomes the elastic member 3300, may the state in which the first hook 3113 and the second hook 3123 lock the table 1000 be released. That is, since the locked state of the table 1000 is not released without a special operation, the reliability of the vehicle table apparatus 1, as perceived by an occupant, may be improved.

In addition, in the vehicle table apparatus 1 according to one embodiment of the present invention, since the locking system 3000 is not installed on the table 1000 but is disposed inside the crash pad C, deterioration of the design freedom and aesthetics of the table 1000 and the crash pad C may be prevented.

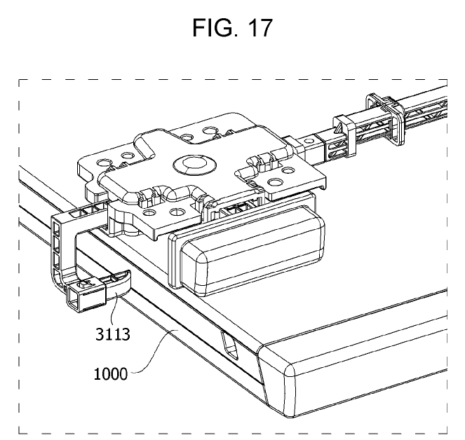

FIG. 17 is a view showing the first hook of the first rod in contact with the table after the table is pulled out.

Referring to FIG. 17, in a state in which the table 1000 is pulled out, the first hook 3113 and the second hook 3123 may be disposed outside the table 1000. More specifically, in the state where the table 1000 is pulled out, the first hook 3113 and the second hook 3123 disposed outside the table 1000 may be in contact with the table 1000 and fix the table 1000. Accordingly, since the shaking of the table 1000 is reduced and the pulled-out state of the table 1000 may be stably maintained, the stability of use of the table 1000 may be improved.

According to one embodiment of the present invention, a locked state of a table by a first hook and a second hook cannot be released when the table is in a stored state, and the locked state of the table by the first hook and the second hook can be released only when a button unit is pressed with a force that overcomes an elastic member. That is, since the table’s locked state is not released without special operation, the reliability of a vehicle table apparatus for an occupant can be improved.

In addition, in a pulled-out state of a table, a first hook and a second hook disposed outside of the table can be in contact with the table to fix the table. Accordingly, as shaking of the table is reduced, a pulled-out state of the table can be stably maintained, thereby improving stability in using the table.

Although the embodiments of the present invention have been described above, it is understood that one ordinarily skilled in the art may make various changes and modifications to the present invention without departing from the spirit and scope of the present invention as hereinafter claimed. Further, it should be construed that differences associated with such changes and modifications fall within the scope of the present invention defined by the accompanying claims.

What is claimed is:

1. A locking system for locking a table disposed in a crash pad of a vehicle in a withdrawable manner, comprising:
a rod unit movably disposed in a housing disposed inside the crash pad and in contact with both ends of the table to hold the table; and
a button unit movably disposed in the housing and configured to press the rod unit to move the rod unit,
wherein the rod unit comprises a first rod and a second rod configured to move in different directions when pressed or released by the button unit.

2. The locking system of claim 1, wherein:
the first rod of the rod unit comprises a first hook configured to pass through the table when pressed by the button unit,
the second rod of the rod unit comprises a second hook configured to pass through the table when pressed by the button unit, and
the first hook and the second hook are disposed outside the table in a pulled-out state and continue to pass through the table in a state in which the table is stored.

3. The locking system of claim 1, comprising:
a disk disposed at an upper side of the housing adapted to rotate in place; and
a link unit connecting the disk and the rod unit.

4. The locking system of claim 3, wherein:
the link unit comprises a first link connecting the disk to the first rod of the rod unit and a second link connecting the disk to the second rod of the rod unit, and
the first link and the second link move in different directions in conjunction with movement of the first rod and the second rod of the rod unit.

5. The locking system of claim 1, wherein the button unit comprises:
a button block disposed to be exposed to the outside of the crash pad; and
a connecting module connecting the button block to the rod unit, and
the connecting module comprises:
a pressing portion disposed inside the crash pad and configured to press the first rod and the second rod of the rod unit; and
a connecting portion connecting the button block to the pressing portion such that the pressing portion is moved in conjunction with movement of the button block.

6. The locking system of claim 5, wherein:
the first rod of the rod unit is provided with a first inclined surface,
the second rod of the rod unit is provided with a second inclined surface symmetrical to the first inclined surface, and
the pressing portion of the button unit is provided with a third inclined surface that comes into contact with the first inclined surface and presses the first inclined surface and a fourth inclined surface that comes into contact with the second inclined surface and presses the second inclined surface.

7. The locking system of claim 6, wherein, when the button unit presses the first rod and the second rod of the rod unit, the first rod and the second rod are moved toward the outside of the table such that the table enters a withdrawable state.

8. The locking system of claim 2, further comprising a first elastic member connecting the housing to the first rod of the rod unit, a second elastic member connecting the housing to the second rod of the rod unit, and a third elastic member connecting the housing to the button unit.

9. A vehicle table apparatus comprising:
a table disposed in a crash pad of a vehicle and configured to move to be pulled out of or stored in the crash pad;
a housing disposed inside the crash pad and configured to movably guide the table; and
a locking system configured to lock or unlock the table disposed in the crash pad,
wherein the locking system comprises:
a rod unit movably disposed in the housing disposed inside the crash pad and in contact with both ends of the table to hold the table; and
a button unit movably disposed in the housing and configured to press the rod unit to move the rod unit, and
the rod unit comprises a first rod and a second rod configured to move in different directions when pressed or released by the button unit.

10. The vehicle table apparatus of claim 9, wherein:
the first rod of the rod unit comprises a first hook configured to pass through the table when pressed by the button unit,
the second rod of the rod unit comprises a second hook configured to pass through the table when pressed by the button unit, and
a first locking groove configured to accommodate the first hook of the first rod and a second locking groove configured to accommodate the second hook of the second rod are formed in the table.
